(19) United States
(12) Patent Application Publication
(10) Pub. No.: US 2017/0102021 A1
(43) Pub. Date: Apr. 13, 2017

(54) GRANULATOR SHEAR PIN SAFETY MECHANISM

(71) Applicant: JIANGSU MUYANG HOLDINGS CO. , LTD., Yangzhou City (CN)

(72) Inventor: Kelsey Curtis Thom, JR., Yangzhou City (CN)

(21) Appl. No.: 15/386,454

(22) Filed: Dec. 21, 2016

Related U.S. Application Data
(63) Continuation-in-part of application No. PCT/CN2014/081783, filed on Jul. 8, 2014.

(30) Foreign Application Priority Data
Jul. 1, 2014 (CN) 201410308346.8
Mar. 22, 2016 (CN) 201620223573.5

(51) Int. Cl. F16B 21/12; A23P 10/25; H01H 3/16; B01J 2/22

(52) U.S. Cl. CPC F16B 21/12; B01J 2/22; A23P 10/25; H01H 3/16

(57) ABSTRACT

A granulator shear pin safety mechanism includes a shear pin housing disposed on a granulator frame or a gear box, a shear pin flange covered on an end surface of the shear pin housing, a shear pin disposed between the housing and the flange, a limit switch disposed on the housing, and a shear pin shroud hinged with the housing. The housing is penetrated by a main shaft of the granulator, the flange is connected to the main shaft, and the shear pin shroud covers a terminal of the main shaft. The limit switch is connected to a power control device. When the limit switch detects that a rotation displacement occurs for the flange, the power control device stops the granulator. A granulator shear pin safety mechanism have a two-piece shear pin shroud, suitable for a granulator having a remote roll adjust drive.

### CROSS-REFERENCE TO RELATED APPLICATIONS

This application is a continuation-in-part application of PCT Application Serial No. PCT/2014/081783, filed Jul. 8, 2014, which itself claims priority to and benefit of Chinese Patent Application No. 201410308346.8, filed Jul. 1, 2014 in the State Intellectual Property Office of P.R. China, the entire contents of which are hereby incorporated by reference.

This application also claims priority to and benefit of Chinese Patent Application No. 201620223573.5, filed Mar. 22, 2016 in the State Intellectual Property Office of P.R. China, the entire content of which is hereby incorporated by reference.

### FIELD OF THE INVENTION

The present invention belongs to the field of food and feed processing equipment, relates generally to a granulator, and more particularly, to a granulator shear pin safety mechanism.

### BACKGROUND OF THE INVENTION

The background description provided herein is for the purpose of generally presenting the context of the present invention and is neither expressly nor impliedly admitted as prior art against the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

A granulator is generally provided with a shear pin for protecting certain parts of the granulator, such as a die, a compression roller, a main shaft, and a gear drive or a belt drive, and specifically for preventing those parts from being damaged by overload during granulation process. The overload may be caused by impurities getting access into a nip between the die and the roller, or by the pelleting difficulty of the feed product. According to the size of the granulator, one, two or three shear pins are generally used for protecting the granulator, where the size of the shear neck of the shear pins can be reinforced to bear 150% to 200% of overload. The shear pin mechanism of the granulator in the related art includes:
1. A shear pin housing fixedly installed on the granulator frame or the gear box.
2. A shear pin flange fixed on the terminal of the main shaft of the granulator.
3. The shear pins are generally installed in the axial or radial position of the shear pin housing and the shear pin flange, and the shear neck of the shear pin is located between the shear pin housing and the shear pin flange.
4. The shear pin mechanism of the granulator is generally arranged at the terminal of the main shaft of the granulator. The terminal is the open end so that the damaged shear pin can be quickly removed. Lubricating line is allowed to connect to the terminal of the main shaft of the granulator through a rapid detacher or a swivel head at the open end of the main shaft. When the granulator is overloaded, the shear pin flange rotates with the main shaft of the granulator. The operator or maintenance personnel is exposed to the rotating shear pin flange, and the rotating shear pin flange may twine the clothes or hair of the operator or maintenance personnel, resulting in personal injury.

In the granulator industry, the open end design has been widely adopted, but this violates the new safety standard recently issued by the North America and the Europe. Therefore, there is a need in the field to design a shear pin safety mechanism for the granulator that meets the new safety standard and avoids the terminal of the main shaft of the granulator from exposing outside.

### SUMMARY OF THE INVENTION

In one aspect, the present invention relates to a shear pin safety mechanism for a granulator that meets the new safety standard of the North America and the Europe, where the terminal of the main shaft of the granulator is enclosed, and the granulator can stop working when the shear pin is cut off.

In one embodiment, a shear pin safety mechanism for a granulator includes a granulator frame or a gear box, a shear pin housing disposed on the granulator frame or the gear box and penetrated by a main shaft of the granulator, a shear pin flange covered on end surface of the shear pin housing and fixed to the main shaft of the granulator, one or more shear pins arranged between the shear pin flange and the shear pin housing, and a first limit switch disposed on the shear pin housing and used for monitoring the rotation displacement of the shear pin flange. The first limit switch is connected to a power control device of the granulator. When the shear pin flange has rotation displacement, the granulator stops working. A protective shear pin shroud is hinged to the shear pin housing, and covers the terminal of the main shaft. When the granulator is overloaded, the shear pins are cut off, the main shaft of the granulator and the shear pin flange rotate along with the die of the granulator, the first limit switch detects the displacement of the shear pin flange, the power control device of the granulator stops the work of the granulator according to the detection of the displacement, and the die and the main shaft of the granulator stop rotating, so that the safety property of the granulator is improved, and the operator or maintenance personnel is prevented from being injured by the rotating shear pin flange. Further, the shear pin shroud encloses the rotating shear pin flange after the granulator is overloaded, thereby avoiding the rotating shear pin flange from contacting the operator or maintenance personnel, and further improving the safety property of the granulator. Even if the first limit switch goes wrong, the shear pin shroud can still enclose and protect the terminal of the main shaft of the granulator.

In one embodiment, one side of the shear pin shroud is hinged with the shear pin housing, and the other side of the shear pin shroud is connected with the shear pin housing through a clamp. A second limit switch is disposed at the position of the clamp, for detecting whether the shear pin shroud is open or not. The second limit switch is connected to the power control device of the granulator. During operation of the granulator, when the shear pin shroud is opened, the granulator stops working. The second limit switch is used for detecting whether the shear pin shroud is in an open potion or a close position, and if the shear pin shroud is in the open position, the granulator will not start.

In one embodiment, a lubricating swivel head for connecting a lubricating line is connected with the terminal of the main shaft of the granulator. The lubricating swivel head is connected with the lubricating line to perform lubrication cooling for the main shaft of the granulator.

In one embodiment, the shear pin shroud is formed with an insertion slot for the lubricating line to pass through. The lubricating line can be connected with the lubricating swivel head through the insertion slot. The shear pin shroud not only encloses and protects the terminal of the main shaft of the granulator, but also allows the lubricating line to perform the lubrication cooling for the main shaft of the granulator.

In one embodiment, the middle portion of the shear pin is opened with a groove, and the groove is located at the fitting end surfaces of the shear pin flange and the shear pin housing.

In one embodiment, there is a gap between the fitting end surface of the shear pin flange and the fitting end surface of the shear pin housing, and the width of the gap is substantially the same as the width of the groove in the middle portion of the shear pin.

Compared with the related art, certain embodiments of the present invention, among other things, have the following beneficial advantages.

The shear pin shroud can enclose the terminal of the main shaft of the granulator and the shear pin flange. Even if the shear pin is cut off due to overload, the rotating main shaft of the granulator and the shear pin flange still have no opportunity to contact the operator or maintenance personnel, thereby improving the safety property of the granulator. When the granulator is overloaded, and the shear pin is cut off, the main shaft of the granulator and the shear pin flange located at the terminal of the main shaft rotate along with the die of the granulator. The first limit switch detects the displacement of the shear pin flange, the power control device of the granulator stops the granulator according to the detection of the displacement, the die and the main shaft of the granulator stop rotating, so that the safety property of the granulator is further improved, and the operator or maintenance personnel is prevented from being injured by the rotating shear pin flange. Through the dual protection of mechanical structure and electronic control, the rotating main shaft of the granulator and the shear pin flange are prevented from contacting the operator or maintenance personnel, so that the granulator according to certain embodiments of the present invention meets new safety standard issued by the North America and the Europe.

In another aspect, the present invention relates to a shear pin safety mechanism for a granulator that having a remote roll adjust drive, and the mechanism includes a two piece shear pin shroud.

In one embodiment, a granulator shear pin safety mechanism for a granulator, includes: a granular supporting frame; a main shaft inserted in the granular supporting frame, and fixed to the granular supporting frame by a shear pin so as to restrict rotation of the main shaft; a remote roll adjust drive installed to an end of the main shaft, and fixed to the granular supporting frame; and a shear pin shroud disposed at an outside of the main shaft. The shear pin shroud includes two shroud pieces in a shape of a clam shell, the two shroud pieces are disposed at two sides of the main shaft, each of the two shroud pieces has a fixing end pivotally connected to the granular supporting arm and a free end, and the two shroud pieces protect the end of the main shaft and the shear pin inside when the two shroud pieces are closed. A latch clip is installed to the shear pin shroud, and configured to lock the two shroud pieces.

In one embodiment, the granulator shear pin safety mechanism further includes a sensor switch fixed to the granular supporting frame. The sensor switch is configured to detect whether the two shroud pieces are open or not, and when the two shroud pieces are detected open, the sensor switch is configure to stop the granulator.

In one embodiment, the granulator shear pin safety mechanism further includes a torsion spring disposed at the fixing ends of the two shroud pieces, to maintain opening positions of the two shroud pieces.

In one embodiment, the granulator shear pin safety mechanism further includes a pneumatic spring disposed between the granular supporting frame and the two shroud pieces, to open the two shroud pieces.

In one embodiment, the granulator shear pin safety mechanism further includes a seat support. The shear pin shroud is pivoted to the seat support through a shear pin, and the remote roll adjust drive is fixed to the sear support through a torsion arm, such that the remote roll adjust drive is fixed to the granular supporting frame.

In one embodiment, the latch clip has a latch connected with one of the shroud pieces, and a hook fixed to the other one of the shroud pieces. The latch has a handle pivoted with the one of the shroud pieces, the handle is hinged with a lock through a rotary shaft, and the handle in operation is configured to engage the lock with the hook.

In one embodiment, the lock is in a shape of C, and includes two vertical sides in parallel and a transverse side between the two vertical sides and perpendicular to the two vertical sides. Each of the two vertical sides is formed with thread, the two vertical sides are respectively inserted through the rotary shaft, a plurality of nuts are disposed at two sides of the rotary shaft and connected to the threads of the two vertical sides, and extension of the lock outside of the rotary shaft is adjusted through rotation of the nuts.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic structural diagram of a granulator shear pin safety mechanism according to one embodiment of the present invention, where the shear pin shroud is open.

FIG. 2 is a schematic structural diagram of a granulator shear pin safety mechanism according to one embodiment of the present invention, where the shear pin shroud is closed.

FIG. 3 is a sectional view of a granulator shear pin safety mechanism according to one embodiment of the present invention.

FIG. 4 is an enlarged view of position A in FIG. 1.

FIG. 5 is a schematic structural diagram of a granulator according to one embodiment of the present invention.

FIG. 6 is a schematic structural diagram of a granulator shear pin safety mechanism according to one embodiment of the present invention.

FIG. 7 is a schematic structural diagram of a granulator shear pin safety mechanism according to one embodiment of the present invention, where the shear pin shroud is open.

FIG. 8 is a schematic structural diagram of a latch clip according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

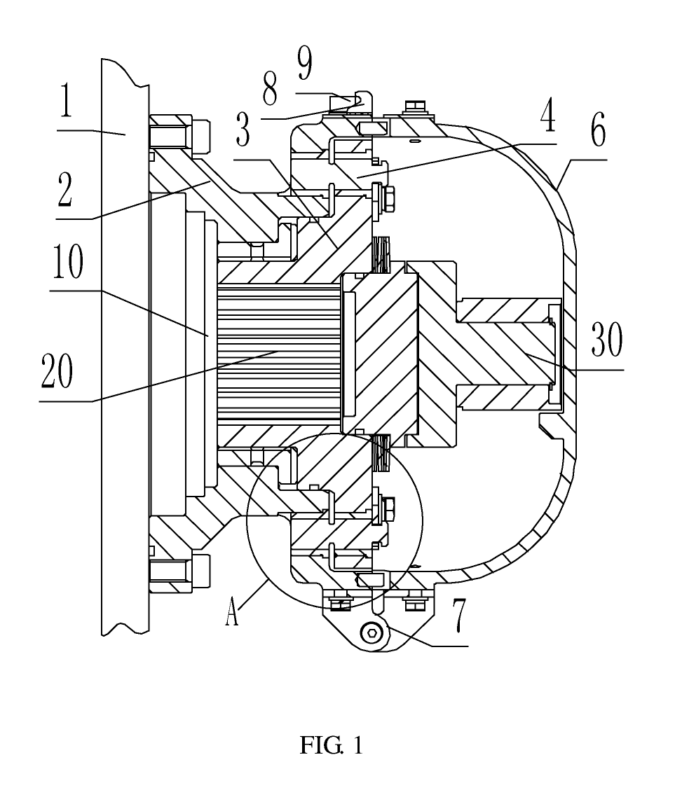

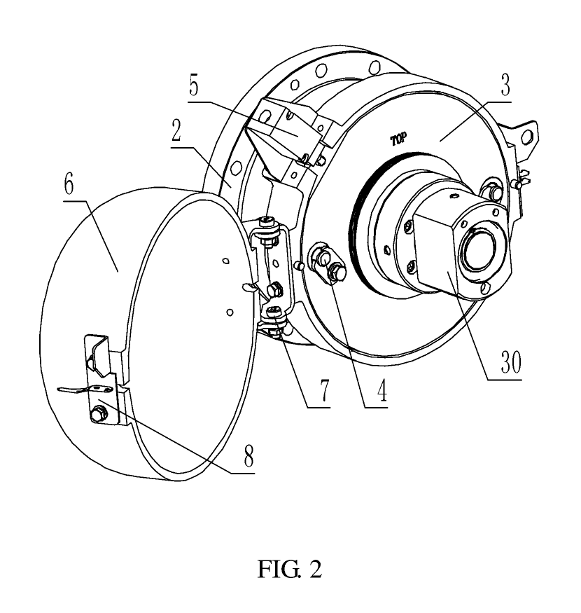

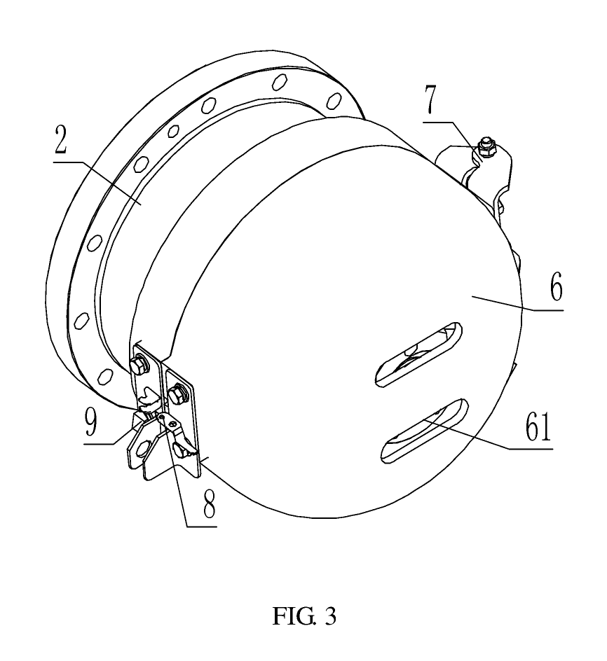

The description will be made as to the embodiments of the present invention in conjunction with the accompanying drawings in FIGS. 1-4. In accordance with the purposes of this invention, as embodied and broadly described herein, this invention, in one aspect, relates to a granulator shear pin safety mechanism.

In certain embodiments, a shear pin safety mechanism of a granulator is shown in FIGS. 1-3. The granulator includes, among other things, a gear box 1, a shear pin housing 2, a shear pin flange 3, one or more shear pins 4, a first limit switch 5, a shear pin shroud 6, a hinge 7, a clamp 8, a second limit switch 9, and a main shaft 10.

The shear pin housing 2 is fixed to one side of the gear box 1 through one or more bolts, and the terminal of the main shaft 10 of the granulator penetrates through the shear pin housing 2. The shear pin flange 3 is covered on the end surface of the shear pin housing 2. One end of the shear pin flange 3 is inserted into the shear pin housing 2, and fixedly connected to the terminal of the main shaft 10 of the granulator through a straight tooth 20. Two shear pins 4 are inserted between the shear pin housing 2 and the shear pin flange 3 along the axial direction of the main shaft 10. When the shear pins 4 are cut off, the shear pin flange 3 rotates together with the main shaft 10 within the shear pin housing 2. The shear pin housing 2 is opened with a notch for installing the first limit switch 5. The first limit switch 5 is used for monitoring the rotation displacement of the shear pin flange 3. The first limit switch 5 is connected with a power control device of the granulator. When the granulator is overloaded and the shear pins are cut off, the shear pin flange 3 rotates with the main shaft 10 of the granulator. Once the first limit switch 5 detects that the shear pin flange 3 is displaced, the first limit switch 5 sends a first signal to the power control device or the power control device retrieves the first signal from the first limit switch 5, and in response to the received first signal, the power control device stops the granulator, thereby prevent the terminal of the main shaft 10 of the granulator and the shear pin flange 3 from continuing rotating.

The shear pin housing 2 is hinged with the shear pin shroud 6. The shear pin shroud 6 is used for enclosing the terminal of the main shaft 10 of the granulator. One side of the shear pin shroud 6 is hinged with the shear pin housing 2 through the hinge 7, and the other side of the shear pin shroud 6 is fixedly connected with the shear pin housing 2 through the clamp 8. The clamp 8 is equipped with a second limit switch 9 for monitoring whether the shear pin shroud 6 is opened, or whether the shear pin shroud 6 is in an open position or a close position. The second limit switch 9 is connected with the power control device. When the shear pin shroud 6 is opened, the second limit switch 9 detects that the shear pin shroud 6 is in the open position, the second limit switch 9 then sends a second signal to the power control device or the power control device retrieves the second signal from the second limit switch 9. In response to the received second signal, the power control device stops the granulator. The terminal of the main shaft 10 of the granulator and the shear pin flange 3 are enclosed by the shear pin shroud 6. The shear pin flange 3 and the main shaft 10 cannot make contact with operator or maintenance personnel, even if they are rotating. Therefore, the safety and protection properties of the granulator are improved.

The terminal of the main shaft 10 of the granulator is connected with the lubricating swivel head 30. The lubricating swivel heard 30 is used for connecting a lubricating line. The shear pin shroud 6 is carved with an insertion slot 61 to let the lubricating line pass through. The lubricating line enters into the shear pin shroud 6 through the insertion slot 61, and is connected with the lubricating swivel head 30.

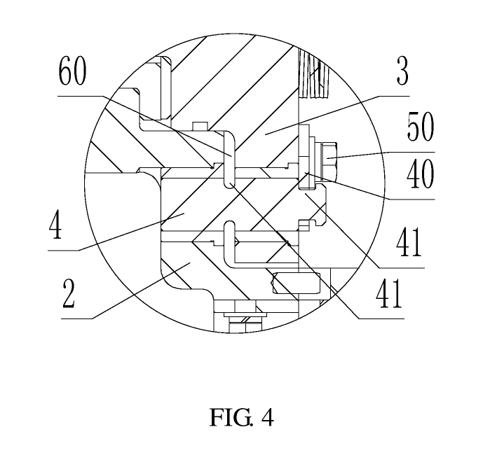

As shown in FIG. 4, the end portion and the middle portion of each shear pin 4 are respectively carved with a groove 41. The shear pin 4 is plugged into the shear pin flange 3 and the shear pin shroud 6. The groove 41 in the middle portion of the shear pin 4 is located on the fitting end surfaces of the shear pin flange 3 and the shear pin housing 2. There exists a gap 60 between the fitting end surface of the shear pin flange 3 and the fitting end surface of the shear pin housing 2. The width of the gap 60 is substantially the same as the width of the groove 41 in the middle portion of the shear pin 4. The groove 41 on the end portion of the shear pin 4 is located on the outer side face of the shear pin flange 3. The groove 41 on the end portion of the shear pin 4 is clamped with a card 40, and the card 40 is fixedly connected with the shear pin flange 3 through a bolt 50. The groove 41 on the end portion of the shear pin 4 is convenient for positioning the card 40 and limiting the plugging-in depth of the shear pin 4, so that the groove 41 in the middle portion of the shear pin 4 is always located at the location of the fitting end surfaces of the shear pin flange 3 and the shear pin shroud 2. The groove 41 in the middle portion of the shear pin 4 is the vulnerable point of the shear pin 4. Thus, when the granulator is overloaded, the shear pin 4 is easily cut off at the location of the groove 41 in the middle portion of the shear pin 4, so that the die, the compression roller and the main shaft 10 are protected from damage.

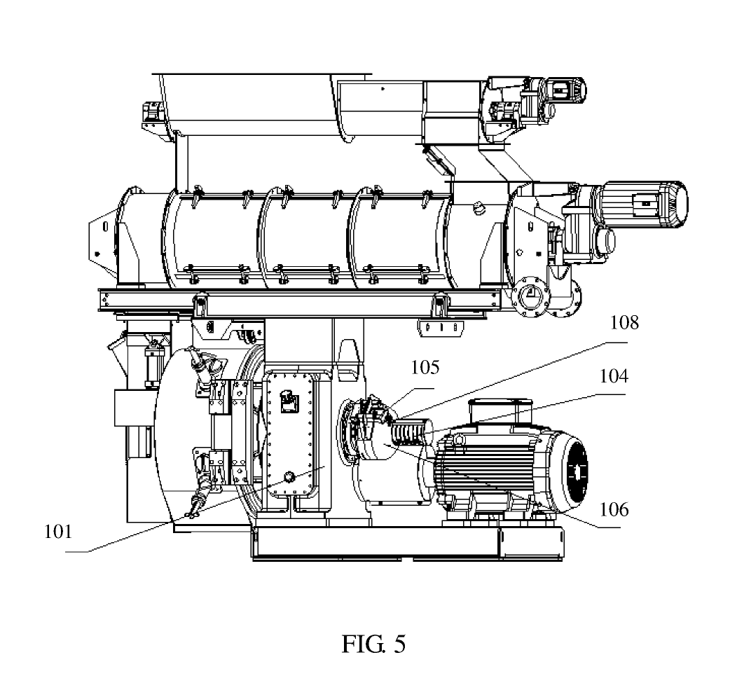

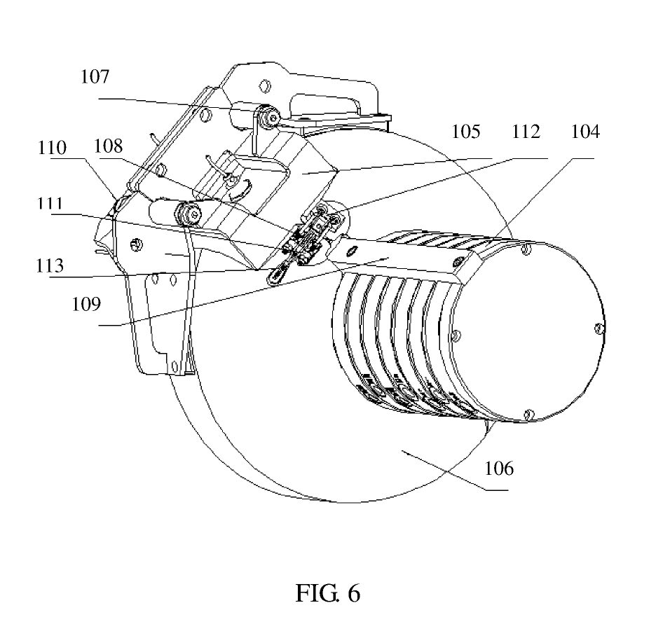

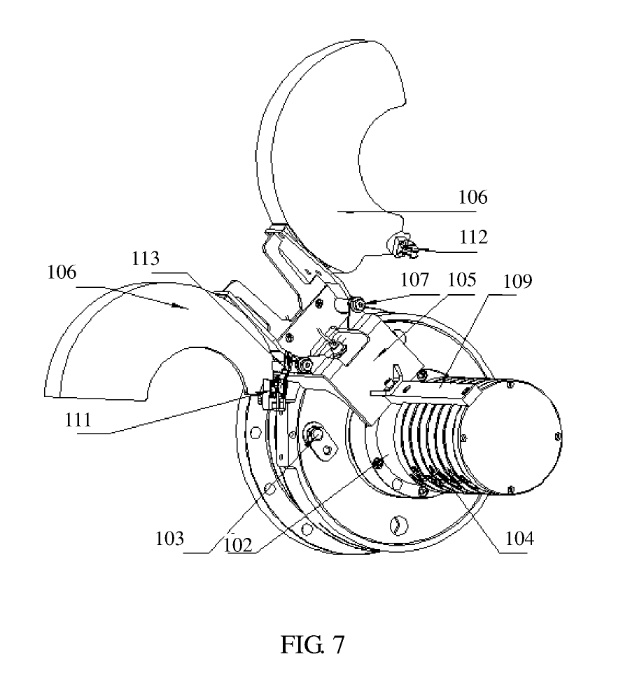

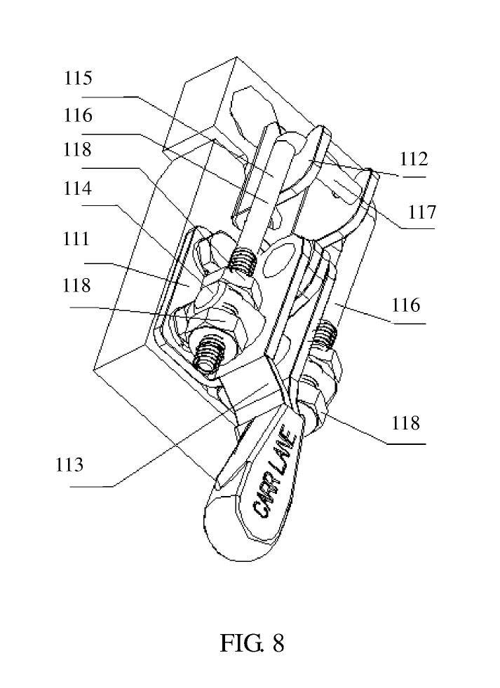

In certain cases, some granulators are equipped with a compression roller remote roll adjust (RRA) drive. Since the RRA is much larger than a manual compression roller adjustment device, it is difficult to use an one-unit shear pin shroud to protect the RRA drive and the shear pin, or the open of the shear pin shroud occupies a large space, which is inconvenient for maintenance operations. Therefore, in another aspect, the present invention relates to a shear pin safety mechanism having a two piece hinged shroud. In certain embodiments, a shear pin shroud of a granulator is shown in FIGS. 5-8. As shown in FIGS. 5-8, a granular shear pin safety mechanism includes a granulator supporting frame 101 to which a main shaft 102 of a compression roller is inserted. The main shaft 102 is fixedly connected to the granulator supporting frame 101 through the shear pin 103 for restricting the rotation of the main shaft 102. When the granulator overloads, the shear pin 103 is cut off, and the main shaft 102 and the compression roller rotate along with the die to protect the compression roller and the main shaft 102 from breaking. An automatic adjusting and driving device 104 is installed at the end of the main shaft 102. A seat support 105 is fixedly installed on the granulator supporting frame 101. The seat support 105 is on an adjacent side of the main shaft 102. Two shroud pieces 106 of a shear pin shroud are pivoted to the seat support 105. The two shroud pieces 106 have an opposite clam shell shape, and are respectively opened on two sides of the main shaft 102. The two shroud pieces 106 having the clam shell shape, when being closed, enclose the end of the main shaft 102 and the shear pin 103. The two shroud pieces 106, when being opened, are suitable for maintenance or replacement of the shear pin 103. One end of each shroud piece 106 is pivoted to the seat support 105 a pin 107, and the other end of the shroud piece 106 is a free end. A latch clip 108 is installed on the two shroud pieces 106. The latch clip 8 closes and locks the two shroud pieces 106. The remote roll adjust drive 104 is fixedly connected with the seat support 105 through a torque arm 109. The torque arm 109 is fixed to the seat support 105. The torque arm 109 is fixed with both the remote roll adjust drive 104 and the granulator to ensure that the remote roll adjust drive 104 never rotates relative to the sear support 105 or the granulator. A sensor switch 110, for detecting whether the clam shell shaped shroud pieces 106 are open or not, is installed on the granulator supporting frame 101. When the shroud pieces 106 are open, the sensor switch 110 turns the granulator off. A torsion spring is installed at the pivotal ends of the shroud pieces 106 to maintain an open status of the shroud pieces 106, or a pneumatic spring is installed at the pivotal ends of the shroud pieces 106 for driving the shroud pieces 106 open. The shroud pieces 106 can be maintained at the maximum opening position by the torsion spring or the pneumatic spring, such that the replacement and the maintenance of the shear pin 103 are convenient. The latch clip 108 includes a latch 111 coupled to one of the shroud pieces 106 and a hook 112 secured to the other one of the shroud pieces 106. The latch 111 includes a handle 113 hinged to the corresponding shroud piece 106. The handle 113 is hinged with a lock 115 through a pivot shaft 114. The lock 115 is in a shape of C, and includes two parallel vertical sides 116 and a transverse side 117 between the two vertical sides 116 and perpendicular to the vertical sides 116. The free end of each of the two vertical sides 116 away from the transverse side 117 is provided with thread. The two vertical sides 116 are respectively inserted into the two rotary shafts 114. Two nuts are connected to the thread of each of the vertical sides 116. The two nuts are fixed on both sides of corresponding one of the rotary shafts 114. The length of each free end of the lock 115 that extends out of the corresponding rotary shafts 114 is adjusted by rotating the corresponding nuts. The handle 113 can be pulled to engage the lock 115 with the hook 112, and then pushed back to achieve locking of the two shroud pieces 106. In this way, the open of the shroud pieces 106 due to vibration is avoided, and the safety of the equipment is ensured. The lock 115 is fixed using threads and nuts. By adjusting the position of the nuts, the extension of the lock 115 out of the rotary shaft 114 is controlled, such that error caused during metal formation can be adjusted.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A granulator shear pin safety mechanism, comprising:
a shear pin housing, disposed on a granulator frame or a gear box of a granulator, and penetrated through by a main shaft of the granulator;
a shear pin flange, covered on an end surface of the shear pin housing, and connected to the main shaft of the granulator;
at least one shear pin arranged between the shear pin flange and the shear pin housing;
a first limit switch, disposed on the shear pin housing and connected to a power control device of the granulator, for detecting whether a rotation displacement occurs for the shear pin flange; and
a shear pin shroud, hinged with the shear pin housing and covering a terminal of the main shaft,
wherein when the first limit switch detects that the rotation displacement occurs for the shear pin flange, the power control device stops the granulator according to the detection that the rotation displacement occurs for the shear pin flange.

2. The granulator shear pin safety mechanism of claim 1, wherein one side of the shear pin shroud is hinged with the shear pin housing, and the other side of the shear pin shroud is connected with the shear pin housing through a clamp; and
the granulator shear pin safety mechanism further comprises a second limit switch disposed on the clamp and connected to the power control device, for determining whether the shear pin shroud is in an open position or not, and when the second limit switch determines that the shear pin shroud is in the open position, the power control device stopes the granulator according to the determination that the shear pin shroud is in the open position.

3. The granulator shear pin safety mechanism of claim 1, wherein the terminal of the main shaft of the granulator is connected with a lubricating swivel head for connecting to a lubricating line.

4. The granulator shear pin safety mechanism of claim 3, wherein the shear pin shroud has an insertion slot for the lubricating line to pass through.

5. The granulator shear pin safety mechanism of claim 1, wherein a middle portion of the shear pin is opened with a groove, and the groove is located at a position of a fitting end surface of the shear pin flange and a fitting end surface of the shear pin housing.

6. The granulator shear pin safety mechanism of claim 5, wherein a gap exists between the fitting end surface of the shear pin flange and the fitting end surface of the shear pin housing, and a width of the gap is substantially the same as a width of the groove in the middle portion of the shear pin.

7. A granulator shear pin safety mechanism for a granulator, comprising:
a granular supporting frame;
a main shaft inserted in the granular supporting frame, and fixed to the granular supporting frame by a shear pin so as to restrict rotation of the main shaft;
a remote roll adjust drive installed to an end of the main shaft, and fixed to the granular supporting frame; and
a shear pin shroud disposed at an outside of the main shaft,
wherein the shear pin shroud includes two shroud pieces in a shape of a clam shell, the two shroud pieces are disposed at two sides of the main shaft, each of the two shroud pieces has a fixing end pivotally connected to the granular supporting arm and a free end, and the two shroud pieces protect the end of the main shaft and the shear pin inside when the two shroud pieces are closed; and
wherein a latch clip is installed to the shear pin shroud, and configured to lock the two shroud pieces.

8. The granulator shear pin safety mechanism of claim 7, further comprising a sensor switch fixed to the granular supporting frame, wherein the sensor switch is configured to detect whether the two shroud pieces are open or not, and when the two shroud pieces are detected open, the sensor switch is configured to stop the granulator.

9. The granulator shear pin safety mechanism of claim 7, further comprising a torsion spring disposed at the fixing ends of the two shroud pieces, to maintain opening positions of the two shroud pieces.

10. The granulator shear pin safety mechanism of claim 7, further comprising a pneumatic spring disposed between the granular supporting frame and the two shroud pieces, to open the two shroud pieces.

11. The granulator shear pin safety mechanism of claim 7, further comprising a seat support, wherein the shear pin shroud is pivoted to the seat support through a shear pin, the remote roll adjust drive is fixed to the sear support through a torsion arm, such that the remote roll adjust drive is fixed to the granular supporting frame.

12. The granulator shear pin safety mechanism of claim 7, wherein the latch clip comprises a latch connected with one of the shroud pieces, and a hook fixed to the other one of the shroud pieces, the latch has a handle pivoted with the one of the shroud pieces, the handle is hinged with a lock through a rotary shaft, the handle in operation is configure to engage the lock with the hook.

13. The granulator shear pin safety mechanism of claim 12, wherein the lock is in a shape of C, and comprises two vertical sides in parallel and a transverse side between the two vertical sides and perpendicular to the two vertical sides, each of the two vertical sides is formed with thread, the two vertical sides are respectively inserted through the rotary shaft, a plurality of nuts are disposed at two sides of the rotary shaft and connected to the threads of the two vertical sides, and extension of the lock outside of the rotary shaft is adjusted through rotation of the nuts.
